(19) United States
(12) Patent Application Publication
(10) Pub. No.: US 2016/0192236 A1
(43) Pub. Date: Jun. 30, 2016

(54) METHOD AND APPARATUS FOR GENERATING EFFICIENT DFT-ED PREAMBLE SEQUENCE

(71) Applicant: Electronics and Telecommunications Research Institute, Daejeon (KR)

(72) Inventors: Kyung Yeol SOHN, Daejeon (KR); Seung Jae BAHNG, Daejeon (KR); Hoon LEE, Daejeon (KR)

(21) Appl. No.: 14/929,630

(22) Filed: Nov. 2, 2015

(30) Foreign Application Priority Data
Dec. 30, 2014 (KR) 10-2014-0193151
Mar. 24, 2015 (KR) 10-2015-0040947

(51) Int. Cl. H04W 28/06; H04W 74/08

(52) U.S. Cl. CPC H04W 28/065; H04W 74/0833

(57) ABSTRACT

Disclosed are a method and an apparatus that efficiently generate a DFT-ed preamble sequence used in uplink PRACH transmission of a wireless communication system. The method for generating a DFT-ed preamble sequence in a wireless communication system includes: calculating a first index value corresponding to the length of a DFT-ed preamble sequence by using control information; extracting a value on a unit circle corresponding to the first index value or a value on the unit circle corresponding to a second index value acquired by transforming the first index value according to a preamble format; reflecting a sign on the unit circle including the corresponding index value to the extracted value on the unit circle; and multiplying a value to which the sign is reflected by an initial sequence value according to a root index.

### CROSS-REFERENCE TO RELATED APPLICATIONS

This application claims priority to and the benefit of Korean Patent Application No. 10-2014-0193151 filed in the Korean Intellectual Property Office on Dec. 30, 2014 and No. 10-2015-0040947 filed in the Korean Intellectual Property Office on Mar. 24, 2015, the entire contents of which are incorporated herein by reference.

### TECHNICAL FIELD

The present invention relates to a method and an apparatus that efficiently generate a DFT-ed preamble sequence used in an uplink PRACH transmission of a wireless communication system, and more particularly, to a method and an apparatus that can generate a DFT-ed preamble sequence in real time and reduce the size of a required memory by using a simplified arithmetic operation and a lookup table storing some of the four quadrants constituting a unit circle.

### BACKGROUND ART

In 3GPP LTE/LTE-A uplink, a scheme called single carrier frequency division multiple access (SC-FDMA) is used, which performs discrete Fourier transform (DFT) before subcarrier mapping in order to solve a peak to average power ratio (PAPR) problem of orthogonal frequency division multiplexing (OFDM) technology. Further, in the 3GPP LTE/LTE-A uplink, uplink synchronization can be achieved by compensating a round trip delay between a base station and a terminal by using a physical random access channel (PRACH) in order to reduce interference which may occur while terminals positioned at a predetermined region in a cell access a network.

In LTE/LTE-A uplink, provided are 5 PRACH preamble formats shown in <Table 1> given below are provided for initial synchronization configuration of the network and used is a DFT-ed preamble sequence using a Zadoff-Chu sequence having a length shown in <Table 2> given below according to the used PRACH preamble format. In this case, as the used Zadoff-Chu sequence, a constant amplitude zero auto correlation (CAZAC) code having excellent auto-correlation and cross-correlation characteristics is used.

TABLE 1

| Preamble format | CP length (T_{CP}) | Sequence length (T_{SEQ}) |
|---|---|---|
| 0 | 3168 · Tₛ | 24576 · Tₛ |
| 1 | 21024 · Tₛ | 24576 · Tₛ |
| 2 | 6240 · Tₛ | 2 · 24576 · Tₛ |
| 3 | 21024 · Tₛ | 2 · 24576 · Tₛ |
| 4 | 448 · Tₛ | 4096 · Tₛ |

TABLE 2

| Preamble format | Sequence length (N_{ZC}) |
|---|---|
| 0~3 | 839 |
| 4 | 139 |

Since a frequency division duplexing (FDD) scheme LTE/LTE-A uplink PRACH uses preamble formats 0 to 3, only a Zadoff-Chu sequence having a length of 839 is used to generate the DFT-ed preamble sequence in order to generate a DFT-ed preamble sequence, but since a time division duplexing (TDD) scheme LTE/LTE-A uplink PRACH uses all of the preamble formats 0 to 4, Zadoff-Chu sequences having Nzc lengths of 839 and 139 are segmented and used according to a cell radius used in the system in order to generate the DFT-ed preamble sequence.

Since the Zadoff-Chu sequence used to generate the PRACH preamble sequence of the LTE/LTE-A uplink fundamentally has a complex number form of the unit circle having a specific phase, the Zadoff-Chu sequence is implemented by segmenting the sequence into a real part and an imaginary part with a trigonometric function calculation in actual hardware and software implementation. A generally known implementation method of the Zadoff-Chu sequence includes a coordinate rotation digital computer (CORDIC) scheme suitable for implementing hardware and the Zadoff-Chu sequence is generally implemented by previously calculating the sequences offline, quantizing the sequences with precision required for the calculation, and thereafter, storing acquired values in a memory, and using only a lookup table and a bit shift operation. The generated values are transformed to a preamble sequence which can be transmitted to the uplink PRACH through DFT.

However, when a 3-sector cell LTE/LTE-A system in which a set of 64 preambles having a length of 839 quantized with 8 bits is allocated to each sector is assumed in configuring the lookup table, a memory with maximum of 2.5 Mbits is required to store the sequences of complex number value. Moreover, since the TDD scheme LTE/LTE-A system needs to also support preambles having a length of 139, approximately 3 Mbits are required as a total memory, and as a result, a large memory quantity is required.

### SUMMARY OF THE INVENTION

The present invention has been made in an effort to provide a method and an apparatus that can generate a DFT-ed preamble sequence in real time and reduce the size of a required memory by using only a simplified arithmetic operation and a lookup table.

An exemplary embodiment of the present invention provides a method for generating a DFT-ed preamble sequence in a wireless communication system, including: calculating a first index value corresponding to the length of a DFT-ed preamble sequence by using control information; extracting a value on a unit circle corresponding to the first index value or a value on the unit circle corresponding to a second index value acquired by transforming the first index value according to a preamble format; reflecting a sign on the unit circle including the corresponding index value to the extracted value on the unit circle; and multiplying a value to which the sign is reflected by an initial sequence value according to a root index.

Another exemplary embodiment of the present invention provides an apparatus for generating a DFT-ed preamble sequence including: an index calculating unit calculating a first index value corresponding to the length of a Zadoff-Chu sequence by using control information; an index transforming unit transforming the first index value into a second index value according to a predetermined index transforming process; a quadrant deciding unit deciding a quadrant on a unit circle including the first index value or the second index value by receiving the first index value and the second index value, respectively from the index calculating unit and the index transforming unit and outputting a sign value of the corresponding quadrant; a lookup table extraction unit extracting a value on the unit circle corresponding to the first index value or the second index value in a lookup table and reflecting the sign value output from the quadrant deciding unit to the extracted value and outputting the corresponding value; an initial sequence calculating unit calculating and outputting an initial sequence value according to a root index; and a multiplier multiplying the output value of the lookup table extraction unit and the output value of the initial sequence calculating unit.

The objects of the present invention are not limited to the aforementioned objects, and other objects, which are not mentioned above, will be apparent to those skilled in the art from the following description.

According to exemplary embodiments of the present invention, an uplink PRACH of a wireless communication system can generate a DFT-ed preamble sequence in real time by using only one look-up table regardless of the length of a Zadoff-Chu sequence according to a preamble format.

In uplink of the wireless communication system, complexity and a required memory size are reduce by using a simplified arithmetic operation for generating the DFT-ed preamble sequence, and as a result, the size and the price of an actual product can be decreased and a chip area and manufacturing cost of the product can be decreased.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a block diagram of generating idx which is an index value for acquiring an N_{zc}-point discrete Fourier transform result according to an exemplary embodiment of the present invention.

FIG. 2 is a diagram illustrating values which exist in each quadrant on a unit circle acquired by using a trigonometric function calculation when N_{zc}=839.

FIG. 3 is a diagram illustrating values which exist in each quadrant of the unit circle acquired by using the trigonometric function calculation when N_{zc}=139.

FIG. 4 is a diagram illustrating values of the unit circle having a length of N=210 configuring a lookup table according to the exemplary embodiment of the present invention.

FIG. 5 is a diagram illustrating a difference between a real number value acquired by using the lookup table and a real number value acquired by using the trigonometric function calculation with respect to N_{zc}=839 according to the exemplary embodiment of the present invention.

FIG. 6 is a diagram illustrating a difference between an imaginary number value acquired by using the lookup table and an imaginary number value acquired by using the trigonometric function calculation with respect to N_{zc}=839 according to the exemplary embodiment of the present invention.

FIG. 7 is a diagram illustrating a difference between a real number value acquired by using the lookup table and a real number value acquired by using the trigonometric function calculation with respect to N_{zc}=139 according to the exemplary embodiment of the present invention.

FIG. 8 is a diagram illustrating a difference between an imaginary number value acquired by using the lookup table and an imaginary number value acquired by using the trigonometric function calculation with respect to N_{zc}=139 according to the exemplary embodiment of the present invention.

FIG. 9 is a block diagram illustrating a configuration of an apparatus for generating a DFT-ed preamble sequence according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known configuration or function related to the present invention may obscure the understanding of an exemplary embodiment of the present invention, the detailed description thereof will be omitted.

A preamble sequence set which may be arbitrarily selected to transmit an uplink PRACH preamble sequence in a terminal in an LTE/LTE-A system is generated from a CAZAC sequence and the acquired preamble sequence set is constituted by a root Zadoff-Chu sequence and sequences cyclically shifted from the root Zadoff-Chu sequence by the unit of cyclic shift. In this case, the used root Zadoff-Chu sequence may be one or more.

The Zadoff-Chu sequence having a root index u having a length of N_{zc} is defined as shown in Equation 1 below.

$${x}_{u} ( n ) = {e}^{- j \frac{π u ( u + 1 )}{{N}_{zc}}} , \\ 0 \leq n < {N}_{zc} \qquad [ Equation 1 ]$$

Where, N_{zc} represents the length of the Zadoff-Chu sequence shown in <Table 2> described above and u corresponds to a positive number which is smaller than N_{zc} which decides characteristics of the Zadoff-Chu sequence.

The Zadoff-Chu sequence cyclically shifted from the Zadoff-Chu sequence having the root index of u is defined as shown in Equation 2 below.

x_{u,v}(n)=xᵤ((n+Cᵥ)mod N_{ZC}) [Equation 2]

Where, Cᵥ represents a cyclic shift value.

The Zadoff-Chu sequence defined as above is transformed into a signal in a frequency domain through Nzc-Point DFT. In this case, the N_{zc}-point DFT may be reconfigured as shown in Equation 3 below with reference to a thesis (“Efficient Computation of DFT of Zadoff-Chu Sequences”, Electronics Letters, Volume 45, No. 9, Apr. 23, 2009, pages 461-463) which can simply express the DFT of the Zadoff-Chu sequence.

$$\begin{matrix}{X}_{u , v} ( k ) = {\sum }_{n = 0}^{{N}_{zc} - 1} {x}_{u , v} ( n ) \cdot {e}^{- j \frac{2 π kn}{{N}_{zc}}} \\ = {\sum }_{n = 0}^{{N}_{zc} - 1} {x}_{u} ( ( n + {C}_{v} ) mod {N}_{zc} ) \cdot {e}^{- j \frac{2 π kn}{{N}_{zc}}} \\ = {\sum }_{n = 0}^{{N}_{zc} - 1} {e}^{- j \frac{π u ( n + {C}_{v} ) ( n + {C}_{v} + 1 )}{{N}_{zc}}} \cdot {e}^{ - j \frac{2 π k n}{{N}_{zc}}} \\ = {e}^{j \frac{π u ( {u}^{- 1} k ) ( 1 + 2 {C}_{v} + {u}^{- 1} k )}{{N}_{z c}}} {\sum }_{n = 0}^{{N}_{zc} - 1} \\ {e}^{- j \frac{π u ( n + {C}_{v} + {u}^{- 1} k ) ( n + {C}_{v} + {u}^{- 1} k + 1 )}{{N}_{zc}}} \\ = {e}^{j \frac{π u ( {u}^{- 1} k ) ( 1 + 2 {C}_{v} + {u}^{- 1} k )}{{N}_{z c}}} {\sum }_{n = 0}^{{N}_{zc} - 1} {x}_{u} ( n + {C}_{v} + {u}^{- 1} k ) \\ = {e}^{j \frac{π u ( {u}^{- 1} k ) ( 1 + 2 {C}_{v} + {u}^{- 1} k )}{{N}_{zc}}} \cdot {X}_{u} ( 0 ) \\ = {e}^{j \frac{2 π k ( 1 + 2 {C}_{v} + {u}^{- 1} k ) \cdot {2}^{- 1}}{{N}_{zc}}} \cdot {X}_{u} ( 0 ) \\ = \{ \begin{matrix}{e}^{j \frac{2 π k ( 1 + 2 {C}_{v} + {u}^{- 1} k ) \cdot 420}{{N}_{zc}}} \cdot {X}_{u} ( 0 ) & for {N}_{zc} = 839 \\ {e}^{j \frac{2 π k ( 1 + 2 {C}_{v} + {u}^{- 1} k ) \cdot 70}{{N}_{zc}}} \cdot {X}_{u} ( 0 ) & for {N}_{zc} = 139\end{matrix}\end{matrix} \qquad [ Equation 3 ]$$

Where, u⁻¹ represents an integer number (multiplicative inverse of u modulo N_{zc}) that satisfies a condition of (u⁻¹×u)modN_{zc}=1, and is (2⁻¹×420)modN_{zc}=1 (for N_{zc}=839) and (2⁻¹×70)modN_{zc}=1 (for N_{zc}=139), and a value of Xu(0) having a constant value may be acquired as shown in Equation 4 below with reference to the thesis (“Efficient DFT of Zadoff-Chu Sequences”, Electronics Letters, Volume 46, No. 7, Apr. 1, 2010, pages 502-503).

$$\begin{matrix}{X}_{u} ( 0 ) = {δ}_{u} \cdot {x}_{u} ( \frac{{N}_{zc} - 1}{2} ) \cdot \frac{1 + {j}^{{N}_{zc}}}{1 + j} \cdot \sqrt{{N}_{zc}} \\ = \sqrt{{N}_{zc}} \cdot {e}^{j \frac{π {α}_{u}}{{N}_{zc}}}\end{matrix} \qquad [ Equation 4 ]$$

Where, δᵤ represents a Jacobi symbol having a value of ±1 according to the u value and a value of αᵤ is given as shown in Equation 5 below according to the value of δᵤ.

$${α}_{u} = \{ \begin{matrix}( 1 - {N}_{zc}^{2} + 6 {N}_{zc} ) / 4 , & if {δ}_{u} = + 1 \\ ( 1 - {N}_{zc}^{2} + 2 {N}_{zc} ) / 4 , & if {δ}_{u} = - 1\end{matrix} \qquad [ Equation 5 ]$$

Therefore, an output of an N_{zc}-Point DFT calculation for the PRACH preamble sequence which is finally acquired may be acquired by first calculating an index value as shown in Equation 6 below according to a k value (=0 to 838 or 0 to 138) according to the size of N_{zc} and multiplying a value output from the lookup table having the N_{zc} size corresponding to a value of a unit circle

$${e}^{j 2 π \frac{i dx}{{N}_{zc}}}$$

(0≦idx≦N_{zc}) for the index value by the constant value Xu(0) when a root index and a cyclic shift value are given.

$$idx = \{ \begin{matrix}( k \cdot ( 1 + 2 {C}_{v} + {u}^{- 1} k ) \cdot 420 ) mod {N}_{zc} & for {N}_{zc} = 839 \\ ( k \cdot ( 1 + 2 {C}_{v} + {u}^{- 1} k ) \cdot 70 ) mod {N}_{zc} & for {N}_{zc} = 139\end{matrix} \qquad [ Equation 6 ]$$

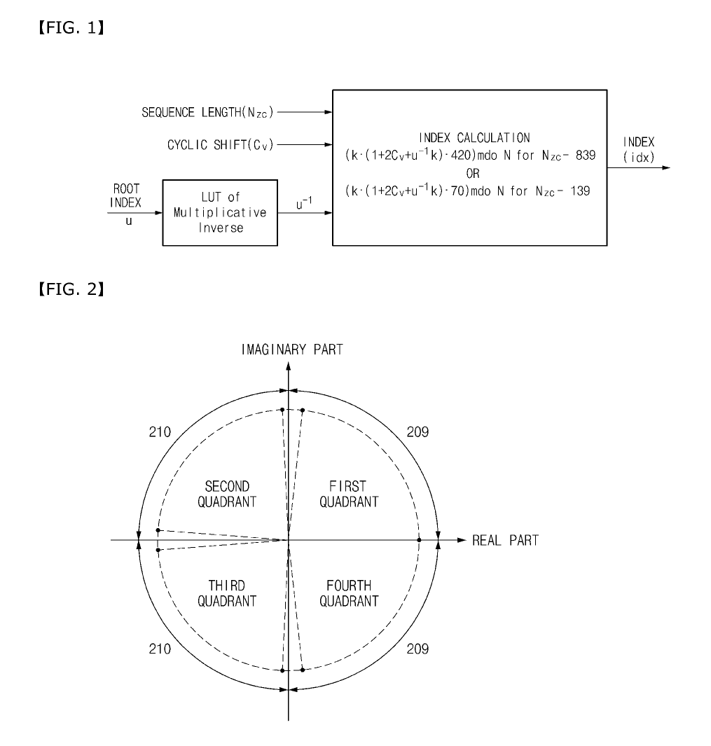

FIG. 1 is a diagram illustrating a block diagram of generating idx which is an index value for acquiring an N_{zc}-point discrete Fourier transform result according to an exemplary embodiment of the present invention and is a block diagram of generating an index value of Equation 6.

When such a method is applied to the TDD scheme LTE/LTE-A system, the size of the required memory may be reduced as compared with a method using a coordinate rotation digital computer (CORDIC). However, two types of lookup tables having values of 839 and 139 on the unit circle need to be provided to generate the preamble sequence according to the preamble format. Further, even when the preamble sequence intends to be generated by using a value of a first quadrant among four quadrants which exist in the unit circle, the number of values which exists for each quadrant is not constant and two types of lookup tables need to be provided for the above reason.

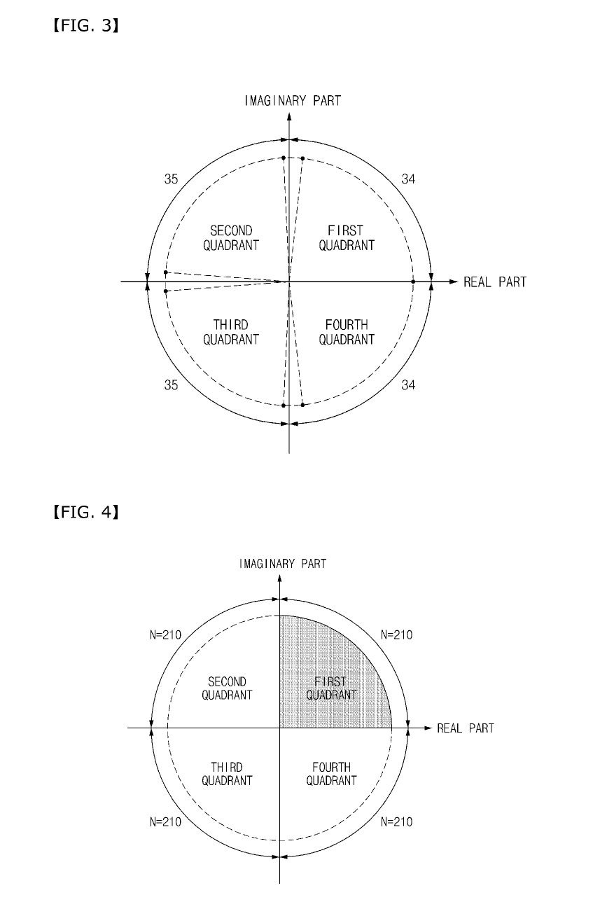

FIG. 2 is a diagram illustrating values which exist in each quadrant on a unit circle acquired by using a trigonometric function calculation when N_{zc}=839 and FIG. 3 is a diagram illustrating values which exist for each quadrant of the unit circle acquired by using the trigonometric function calculation when N_{zc}=139.

The values of the unit circle of FIGS. 2 and 3 are given as shown in Equation 7 below.

$${e}^{j 2 π \frac{Idx}{{N}_{zc}}} , \\ 0 \leq Idx \leq {N}_{zc} - 1 \qquad [ Equation 7 ]$$

As illustrated in FIGS. 2 and 3, it can be seen that the values which exists on each quadrant are 209 and 210 when N_{zc}=839 and are 34 and 35 when N_{zc}=139 and the number of values which exist on each quadrant is not constant and the values are not constant.

FIG. 4 is a diagram illustrating values of the unit circle having a length of N=210 configuring a lookup table according to the exemplary embodiment of the present invention.

In the present invention, it is assumed that the number of values of the unit circle is 840 and 140 according to the preamble format. In this case, the number of values which exist for four quadrants of the unit circle is constantly maintained as 210 and 35. Further, since 210 values that exist in the quadrant have a structure including 35 values of the unit circle corresponding to preamble format 4, when only one lookup table including N=210 which exists on the first quadrant is used, all DFT-ed preamble sequences may be generated regardless of the preamble format.

That is, when N_{zc}=839, a quadrant including the corresponding index is determined by using an index value (first index value) and thereafter, a sign of the corresponding quadrant is reflected to a value acquired in the lookup table by using the first index value and multiplied by the constant value Xu(0) to generate the DFT-ed preamble sequence.

However, when N_{zc}=139, a quadrant including the corresponding index is determined (decided) by using the index value (first index value) and thereafter, a sign of the corresponding quadrant is reflected to a value acquired in the lookup table by using a second index value acquired through an index transformation process (a process of transforming 35 values of the unit circle corresponding to preamble format 4 into 210 values) for the first index value and multiplied by the constant value Xu(0) to generate the DFT-ed preamble sequence. Alternatively, when N_{zc}=139, the quadrant is determined by using the second index value which is acquired first through the index transformation process for the first index value and thereafter, a sign of the corresponding quadrant is reflected to the value acquired in the lookup table by using the second index value and multiplied by the constant value Xu(0) to generate the DFT-ed preamble sequence.

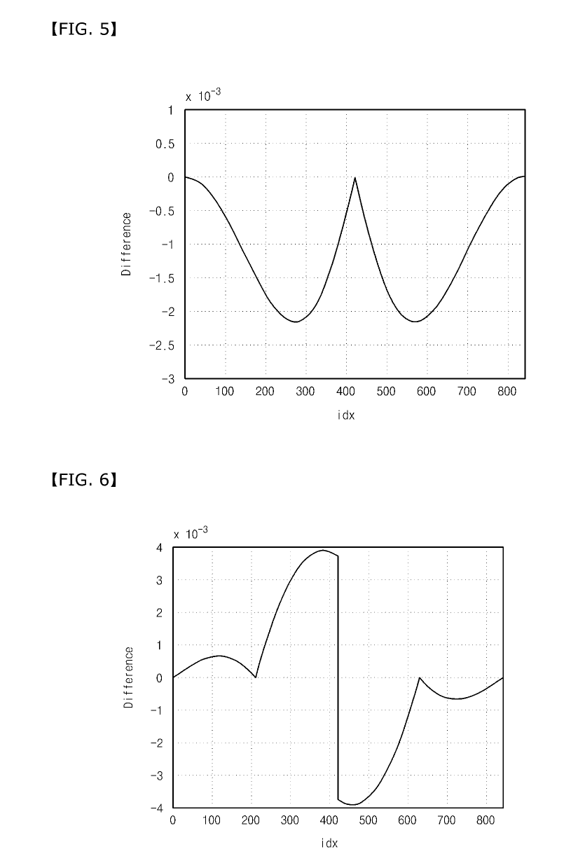

FIG. 5 is a diagram illustrating a difference between a real number value acquired by using the lookup table and a real number value acquired by using the trigonometric function calculation with respect to N_{zc}=839 according to the exemplary embodiment of the present invention.

FIG. 6 is a diagram illustrating a difference between an imaginary number value acquired by using the lookup table and an imaginary number value acquired by using the trigonometric function calculation with respect to N_{zc}=839 according to the exemplary embodiment of the present invention.

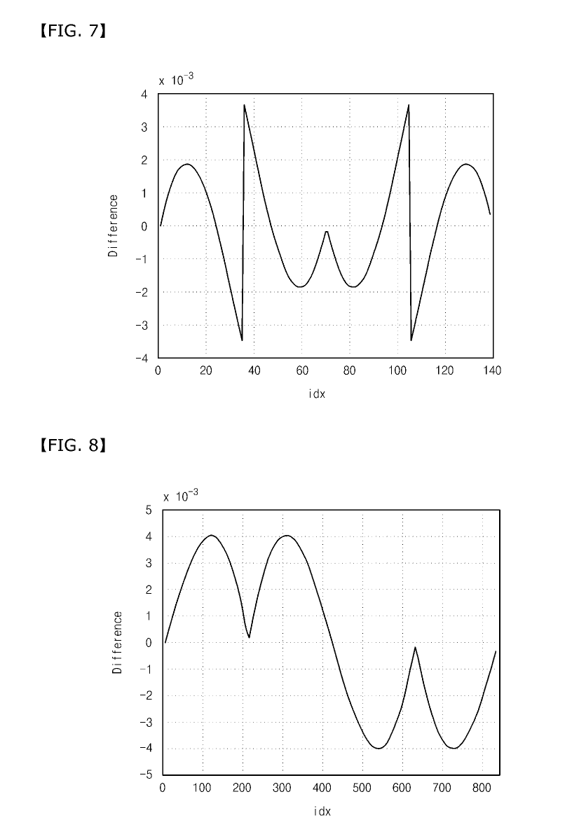

FIG. 7 is a diagram illustrating a difference between a real number value acquired by using the lookup table and a real number value acquired by using the trigonometric function calculation with respect to N_{zc}=139 according to the exemplary embodiment of the present invention.

FIG. 8 is a diagram illustrating a difference between an imaginary number value acquired by using the lookup table and an imaginary number value acquired by using the trigonometric function calculation with respect to N_{zc}=139 according to the exemplary embodiment of the present invention.

In the results of FIGS. 5, 6, 7, and 8, it is assumed that the number of values which exist for the unit circle is 840 and 140 according to the preamble format and since both a real number value and an imaginary number value of a difference between the Zadoff-Chu sequence generated by using the lookup table including N=210 which exists in the first quadrant of the unit circle and the Zadoff-Chu sequence acquired by using a trigonometric function has a value of 5×10⁻³ or less, the lookup table including N=210 may be used to generate the DFT-ed preamble sequence.

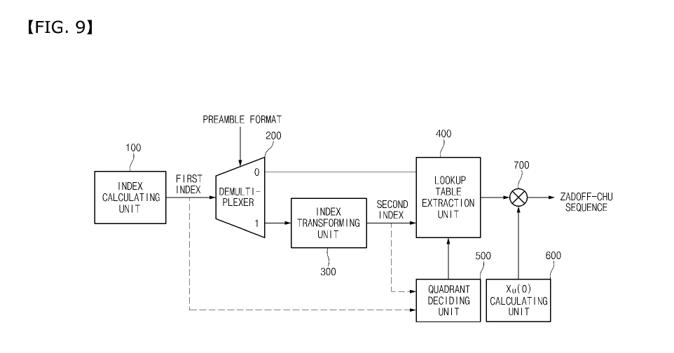

FIG. 9 is a diagram illustrating a configuration of an apparatus for generating a DFT-ed preamble sequence according to an exemplary embodiment of the present invention.

Referring to FIG. 9, the apparatus for generating a DFT-ed preamble sequence according to the exemplary embodiment of the present invention includes an index calculating unit 100, a demultiplexer 200, an index transforming unit 300, a lookup table extraction unit 400, a quadrant deciding unit 500, an Xu(0) calculating unit 600, and a multiplier 700.

When control information, for example, a root index, the cyclic shift, and the length of the Zadoff-Chu sequence are given, the index calculating unit 100 calculates the index value (first index value) corresponding to the sequence length and thereafter, transfers the value to the demultiplexer 200 and the quadrant deciding unit 500. In this case, the index calculating unit 100 may have the configuration shown in FIG. 1 and the first index value may be acquired as shown in Equation 6 above.

The demultiplexer 200 transfers the first index value to the index transforming unit 300 or the lookup table extraction unit 400 according to the PRACH preamble format to be transmitted. For example, the demultiplexer 200 transfers the first index value to the lookup table extraction unit 400 when the preamble format is 0 to 3 (N_{zc}=839) and the first index value to the index transforming unit 300 when the preamble format is 4 (N_{zc}=139).

The index transforming unit 300 index-transforms the first index value received from the demultiplexer 200 into the second index value, and thereafter, transfers the second index value to the lookup table 400 and the quadrant deciding unit 500. For example, the index transforming unit 300 transforms the first index value received from the demultiplexer 200 into the second index value and thereafter, transfers the transformed second index value to the lookup table 400 and the quadrant deciding unit 500 by using an index transforming process of transforming 35 index values (0 to 34) which exist in each quadrant of the unit circle into 210 second index values (0 to 209).

The quadrant deciding unit 500 decides the quadrant of the unit circle including the corresponding value by using the first index value from the index calculating unit 100 or the second index value from the index transforming unit 300 and thereafter, transfers a sign value of the corresponding quadrant to the lookup table extraction unit 400. For example, the quadrant deciding unit 500 decides a quadrant including the first index value by using the first index value from the index calculating unit 100 when N_{zc}=839 and decides a quadrant including the first index value by using the first index value from the index calculating unit 100 when N_{zc}=139 or decides a quadrant including the second index value by using the second index value from the index transforming unit 300. That is, the quadrant deciding unit 500 decides a quadrant including the first index value by determining that N_{zc}=839 when receiving only the first index value from the index calculating unit 100 and decides a quadrant including the corresponding index value by using the first index value or the second index value by determining that N_{zc}=139 when receiving even the second index value from the index transforming unit 300 as well as the first index value.

The lookup table extraction unit 400 extracts a value of the unit circle corresponding to the first index value transmitted from the demultiplexer 200 in a lookup table previously stored in the memory or the second index value transmitted from the index transforming unit 300 and reflects the sign value transmitted from the quadrant deciding unit 500 to the extracted value and transfers the reflected sign value to the multiplier 700. The lookup table extraction unit 400 extracts the value of the unit circle corresponding to the first index value when receiving the first index value from the demultiplexer 200 and extracts the value of the unit circle corresponding to the second index value when receiving the second index value from the index transforming unit 300. In this case, the lookup table stores values for a case in which 210 values exist for each quadrant as shown in FIG. 4.

The Xu(0) calculating unit 600 calculates a constant value (initial sequence value) Xu(0) according to the root index and transfers the calculated constant value to the multiplier 700. In this case, the constant value Xu(0) may be acquired as shown in Equation 4 above.

The multiplier 700 multiplies the value of the unit circle transmitted from the lookup table extraction unit 400 and the constant value transmitted from the Xu(0) calculating unit 600 by each other to generate a final DFT-ed preamble sequence.

Various exemplary embodiments of the present invention have been just exemplarily described, and various changes and modifications may be made by those skilled in the art to which the present invention pertains without departing from the scope and spirit of the present invention.

Accordingly, the various embodiments disclosed herein are not intended to limit the technical spirit but describe with the true scope and spirit being indicated by the following claims. The scope of the present invention should be interpreted by the appended claims, and all the technical spirit in the equivalent range should be interpreted to be embraced in the scope of the present invention.

What is claimed is:

1. An apparatus for generating a DFT-ed preamble sequence, the apparatus comprising:
an index calculating unit calculating a first index value corresponding to the length of a Zadoff-Chu sequence by using control information;
an index transforming unit transforming the first index value into a second index value according to a predetermined index transforming process;
a quadrant deciding unit deciding a quadrant on a unit circle including the first index value or the second index value by receiving the first index value and the second index value, respectively from the index calculating unit and the index transforming unit and outputting a sign value of the corresponding quadrant;
a lookup table extraction unit extracting a value on the unit circle corresponding to the first index value or the second index value in a lookup table and reflecting the sign value output from the quadrant deciding unit to the extracted value and outputting the corresponding value;
an initial sequence calculating unit calculating and outputting an initial sequence value according to a root index; and
a multiplier multiplying the output value of the lookup table extraction unit and the output value of the initial sequence calculating unit.

2. The apparatus of claim 1, further comprising:
a demultiplexer selectively transmitting the first index value calculated in the index calculating unit to the lookup table extraction unit or the index transforming unit according to the preamble format.

3. The apparatus of claim 2, wherein the preamble format is a physical random access channel (PRACH) preamble format.

4. The apparatus of claim 2, wherein the lookup table extraction unit extracts a value on the unit circle corresponding to the first index value when receiving the first index value from the demultiplexer, and extracts a value on the unit circle corresponding to the second index value and reflects a sign value output from the quadrant deciding unit when receiving the second index value from the index transforming unit.

5. The apparatus of claim 1, wherein the index transforming unit transforms the first index value into the second index value by using an index transforming process of transforming 35 index values (0 to 34) which exist on the unit circle into 210 index values (0 to 209).

6. The apparatus of claim 1, wherein the quadrant deciding unit decides a quadrant including the first index value when receiving only the first index value and decides a quadrant including the first index value or the second index value when receiving both the first index value and the second index value.

7. A method for generating a DFT-ed preamble sequence in a wireless communication system, the method comprising:
calculating a first index value corresponding to the length of a DFT-ed preamble sequence by using control information;
extracting a value on a unit circle corresponding to the first index value or a value on the unit circle corresponding to a second index value acquired by transforming the first index value according to a preamble format;
reflecting a sign on the unit circle including the corresponding index value to the extracted value on the unit circle; and
multiplying a value to which the sign is reflected by an initial sequence value according to a root index.

8. The method of claim 7, wherein the preamble format is a physical random access channel (PRACH) preamble format.

9. The method of claim 8, wherein in the extracting of the value on the unit circle, the value on the unit circle corresponding to the first index value is extracted when the preamble format is 0 to 3 and the value on the unit circle corresponding to the second index value is extracted from the lookup table when the preamble format is 4.

10. The method of claim 9, wherein the second index value is a value acquired by transforming 35 index values (0 to 34) which exist on the quadrant on the unit circle into 210 index values (0 to 209).

11. The method of claim 7, wherein in the reflecting of the sign on the unit circle, the sign on the unit circle including the first index value is reflected when the preamble format is 0 to 3 and the sign on the unit circle including the first index value or the sign on the unit circle including the second index value is reflected when the preamble format is 4.

12. The method of claim 7, wherein the control information includes a root index, a cyclic shift, and the length of a Zadoff-Chu sequence.
